(19) United States
(12) Patent Application Publication
(10) Pub. No.: US 2018/0026466 A1
(43) Pub. Date: Jan. 25, 2018

(54) CHARGING DISCHARGING APPARATUS FOR SUPER CAPACITOR MODULES

(71) Applicant: AVALUE TECHNOLOGY INC., New Taipei City (TW)

(72) Inventor: Bar-Chung HWANG, New Taipei City (TW)

(21) Appl. No.: 15/218,251

(22) Filed: Jul. 25, 2016

(51) Int. Cl. H02J 7/00

(52) U.S. Cl. CPC H02J 7/0068; H02J 7/0072; H02J 7/345

(57) ABSTRACT

A charging discharging apparatus includes a control unit, a first switch unit, a second switch unit, a third switch unit, a fourth switch unit and a fifth switch unit. When an input power apparatus sends an input power to the charging discharging apparatus, the control unit turns off the second switch unit and the fourth switch unit, and the control unit turns on the first switch unit, the third switch unit and the fifth switch unit, so that a power load apparatus receives the input power through the first switch unit, and the first super capacitor module is connected to the second super capacitor module in parallel, and the first super capacitor module and the second super capacitor module are charged.

### BACKGROUND OF THE INVENTION

### Field of the Invention

The present invention relates to a charging discharging apparatus, and especially relates to a charging discharging apparatus for super capacitor modules.

### Description of the Related Art

There are two types of the related art charging discharging apparatuses for super capacitor modules: the related art parallel type charging discharging apparatus and the related art serial type charging discharging apparatus.

The advantage of the related art parallel type charging discharging apparatus is that when the related art parallel type charging discharging apparatus charges to a plurality of super capacitor modules, the super capacitor modules are connected to each other in parallel, so that the circuit of the related art parallel type charging discharging apparatus is simple (usually does not need the voltage-boosting circuit). The disadvantage of the related art parallel type charging discharging apparatus is that when the super capacitor modules discharge to the power load apparatus through the related art parallel type charging discharging apparatus, the super capacitor modules are not connected to each other in series, so that the super capacitor modules remain much electricity.

The advantage of the related art serial type charging discharging apparatus is that when the super capacitor modules discharge to the power load apparatus through the related art serial type charging discharging apparatus, the super capacitor modules are connected to each other in series, so that the super capacitor modules do not remain much electricity. The disadvantage of the related art serial type charging discharging apparatus is that when the related art serial type charging discharging apparatus charges to the super capacitor modules, the super capacitor modules are connected to each other in series, so that the circuit of the related art serial type charging discharging apparatus is complicated (usually needs the higher input voltage or the voltage-boosting circuit).

### SUMMARY OF THE INVENTION

In order to solve the above-mentioned problems, an object of the present invention is to provide a charging discharging apparatus for super capacitor modules.

In order to achieve the object of the present invention mentioned above, the charging discharging apparatus is applied to an input power apparatus, a power load apparatus, a first super capacitor module and a second super capacitor module. A negative terminal of the first super capacitor module is connected to ground. The charging discharging apparatus comprises a control unit, a first switch unit, a second switch unit, a third switch unit, a fourth switch unit and a fifth switch unit. The first switch unit is electrically connected to the control unit, the input power apparatus and the power load apparatus. The second switch unit is electrically connected to the control unit, the power load apparatus, the first switch unit and the second super capacitor module. The third switch unit is electrically connected to the control unit, the second switch unit, the second super capacitor module and the first super capacitor module. The fourth switch unit is electrically connected to the control unit, a negative terminal of the second super capacitor module, the third switch unit and the first super capacitor module. The fifth switch unit is electrically connected to the control unit, the fourth switch unit, the negative terminal of the first super capacitor module, the negative terminal of the second super capacitor module and ground. When the input power apparatus sends an input power to the charging discharging apparatus, the control unit turns off the second switch unit and the fourth switch unit, and the control unit turns on the first switch unit, the third switch unit and the fifth switch unit, so that the power load apparatus receives the input power through the first switch unit, and the first super capacitor module is connected to the second super capacitor module in parallel, and the first super capacitor module and the second super capacitor module are charged. When the input power apparatus stops sending the input power to the charging discharging apparatus, the control unit turns off the first switch unit, the third switch unit and the fifth switch unit, and the control unit turns on the second switch unit and the fourth switch unit, so that the first super capacitor module is connected to the second super capacitor module in series, and the first super capacitor module and the second super capacitor module discharge to the power load apparatus through the second switch unit and the fourth switch unit.

Moreover, the charging discharging apparatus further comprises an input power detection unit electrically connected to the control unit, the input power apparatus and the first switch unit. The input power detection unit detects the input power and informs the control unit of a status of the input power, so that the control unit is aware that whether the input power apparatus sends the input power to the charging discharging apparatus or not. When the input power apparatus sends the input power to the charging discharging apparatus, the input power detection unit detects the input power and informs the control unit that the input power is sent to the charging discharging apparatus, so that the control unit is aware that the input power apparatus sends the input power to the charging discharging apparatus. When the input power apparatus does not send the input power to the charging discharging apparatus, the input power detection unit does not detect the input power and informs the control unit that the input power detection unit does not detect the input power, so that the control unit is aware that the input power apparatus does not send the input power to the charging discharging apparatus.

Moreover, the charging discharging apparatus further comprises a charging unit electrically connected to the control unit, the input power apparatus, the first switch unit, the input power detection unit, the third switch unit, the fourth switch unit and the first super capacitor module. When the input power apparatus sends the input power to the charging discharging apparatus, the control unit controls the charging unit to receive the input power to charge to the first super capacitor module and the second super capacitor module.

Moreover, the control unit is a microcontroller, a microprocessor or a logic circuit.

Moreover, the first switch unit is a metal oxide semiconductor field effect transistor or a bipolar junction transistor. The second switch unit is a metal oxide semiconductor field effect transistor or a bipolar junction transistor. The third switch unit is a metal oxide semiconductor field effect transistor or a bipolar junction transistor. The fourth switch unit is a metal oxide semiconductor field effect transistor or a bipolar junction transistor. The fifth switch unit is a metal oxide semiconductor field effect transistor or a bipolar junction transistor.

Moreover, the input power detection unit is an input power detection circuit.

Moreover, the charging unit is a charging circuit.

The advantage of the present invention is that the charging discharging apparatus has both the advantages of the charging in parallel and discharging in series, but the present invention does not have the disadvantages of the discharging in parallel and charging in series.

### BRIEF DESCRIPTION OF DRAWING

FIG. 1 shows a block diagram of the first embodiment of the charging discharging apparatus of the present invention.

FIG. 2 shows a block diagram of the second embodiment of the charging discharging apparatus of the present invention.

### DETAILED DESCRIPTION OF THE INVENTION

Please refer to following detailed description and figures for the technical content of the present invention. The following detailed description and figures are referred for the present invention, but the present invention is not limited to it.

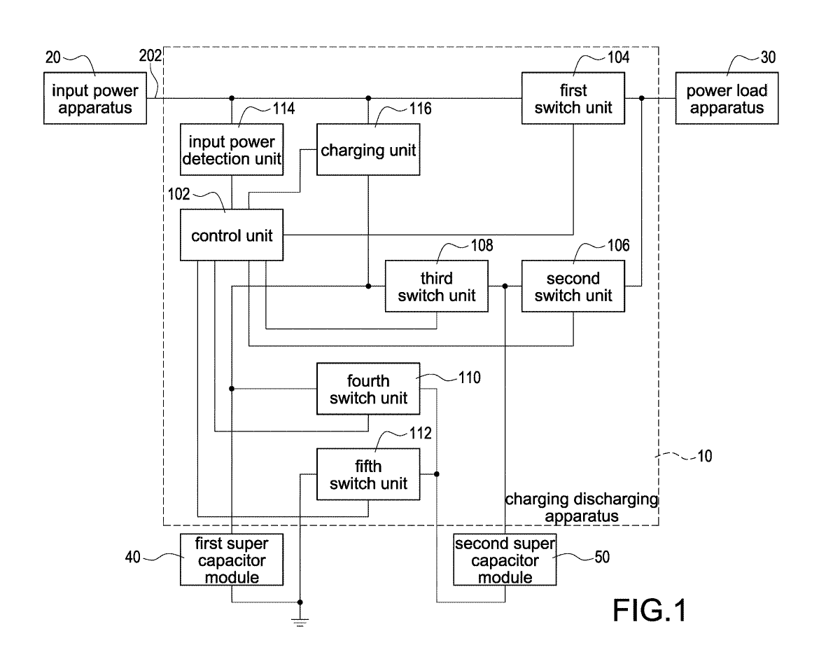

FIG. 1 shows a block diagram of the first embodiment of the charging discharging apparatus of the present invention. A charging discharging apparatus 10 is applied to an input power apparatus 20, a power load apparatus 30, a first super capacitor module 40 and a second super capacitor module 50. The charging discharging apparatus 10 comprises a control unit 102, a first switch unit 104, a second switch unit 106, a third switch unit 108, a fourth switch unit 110, a fifth switch unit 112, an input power detection unit 114 and a charging unit 116.

A negative terminal of the first super capacitor module 40 is connected to ground. The first switch unit 104 is electrically connected to the control unit 102, the input power apparatus 20 and the power load apparatus 30. The second switch unit 106 is electrically connected to the control unit 102, the power load apparatus 30, the first switch unit 104 and the second super capacitor module 50. The third switch unit 108 is electrically connected to the control unit 102, the second switch unit 106, the second super capacitor module 50 and the first super capacitor module 40. The fourth switch unit 110 is electrically connected to the control unit 102, a negative terminal of the second super capacitor module 50, the third switch unit 108 and the first super capacitor module 40. The fifth switch unit 112 is electrically connected to the control unit 102, the fourth switch unit 110, the negative terminal of the first super capacitor module 40, the negative terminal of the second super capacitor module 50 and ground. The input power detection unit 114 is electrically connected to the control unit 102, the input power apparatus 20 and the first switch unit 104. The charging unit 116 is electrically connected to the control unit 102, the input power apparatus 20, the first switch unit 104, the input power detection unit 114, the third switch unit 108, the fourth switch unit 110 and the first super capacitor module 40.

When the input power apparatus 20 sends an input power 202 to the charging discharging apparatus 10, the control unit 102 turns off the second switch unit 106 and the fourth switch unit 110, and the control unit 102 turns on the first switch unit 104, the third switch unit 108 and the fifth switch unit 112, so that the power load apparatus 30 receives the input power 202 through the first switch unit 104, and the first super capacitor module 40 is connected to the second super capacitor module 50 in parallel, and the first super capacitor module 40 and the second super capacitor module 50 are charged.

In an embodiment, the control unit 102 firstly turns off the second switch unit 106 and the fourth switch unit 110, and then after a delay time, the control unit 102 turns on the first switch unit 104, the third switch unit 108 and the fifth switch unit 112 to avoid the transient short circuit phenomenon.

When the input power apparatus 20 stops sending the input power 202 to the charging discharging apparatus 10, the control unit 102 turns off the first switch unit 104, the third switch unit 108 and the fifth switch unit 112, and the control unit 102 turns on the second switch unit 106 and the fourth switch unit 110, so that the first super capacitor module 40 is connected to the second super capacitor module 50 in series, and the first super capacitor module 40 and the second super capacitor module 50 discharge to the power load apparatus 30 through the second switch unit 106 and the fourth switch unit 110.

In an embodiment, the control unit 102 firstly turns off the first switch unit 104, the third switch unit 108 and the fifth switch unit 112, and then after the delay time, the control unit 102 turns on the second switch unit 106 and the fourth switch unit 110 to avoid the transient short circuit phenomenon.

The input power detection unit 114 detects the input power 202 and informs the control unit 102 of a status of the input power 202, so that the control unit 102 is aware that whether the input power apparatus 20 sends the input power 202 to the charging discharging apparatus 10 or not. When the input power apparatus 20 sends the input power 202 to the charging discharging apparatus 10, the input power detection unit 114 detects the input power 202 and informs the control unit 102 that the input power 202 is sent to the charging discharging apparatus 10, so that the control unit 102 is aware that the input power apparatus 20 sends the input power 202 to the charging discharging apparatus 10. When the input power apparatus 20 does not send the input power 202 to the charging discharging apparatus 10, the input power detection unit 114 does not detect the input power 202 and informs the control unit 102 that the input power detection unit 114 does not detect the input power 202, so that the control unit 102 is aware that the input power apparatus 20 does not send the input power 202 to the charging discharging apparatus 10.

When the input power apparatus 20 sends the input power 202 to the charging discharging apparatus 10, the control unit 102 controls the charging unit 116 to receive the input power 202 to charge to the first super capacitor module 40 and the second super capacitor module 50.

The control unit 102 is a microcontroller, a microprocessor or a logic circuit. The response of the logic circuit is faster than the responses of the microcontroller or the microprocessor. The logic circuit can send out conduction signals or non-conduction signals to the first switch unit 104, the second switch unit 106, the third switch unit 108, the fourth switch unit 110 and the fifth switch unit 112 in the shortest time. The first switch unit 104 is a metal oxide semiconductor field effect transistor or a bipolar junction transistor. The second switch unit 106 is a metal oxide semiconductor field effect transistor or a bipolar junction transistor. The third switch unit 108 is a metal oxide semiconductor field effect transistor or a bipolar junction transistor. The fourth switch unit 110 is a metal oxide semiconductor field effect transistor or a bipolar junction transistor. The fifth switch unit 112 is a metal oxide semiconductor field effect transistor or a bipolar junction transistor. The input power detection unit 114 is an input power detection circuit. The charging unit 116 is a charging circuit.

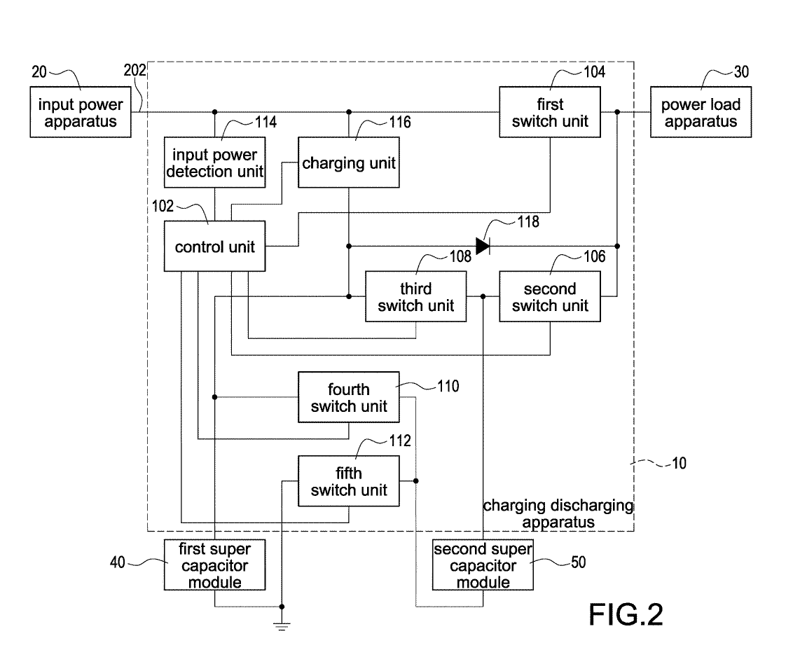

Moreover, FIG. 2 shows a block diagram of the second embodiment of the charging discharging apparatus of the present invention. The description for the elements shown in FIG. 2, which are similar to those shown in FIG. 1, is not repeated here for brevity. Moreover, the charging discharging apparatus 10 further comprises a diode 118 electrically connected to the first switch unit 104, the power load apparatus 30, the second switch unit 106, the charging unit 116, the third switch unit 108, the fourth switch unit 110 and the first super capacitor module 40.

In an instant when the input power apparatus 20 stops sending the input power 202 to the charging discharging apparatus 10, the control unit 102 does not turn off the first switch unit 104, the third switch unit 108 and the fifth switch unit 112 yet (namely, the first switch unit 104, the third switch unit 108 and the fifth switch unit 112 are still turned on), and the control unit 102 does not turn on the second switch unit 106 and the fourth switch unit 110 yet (namely, the second switch unit 106 and the fourth switch unit 110 are still turned off), so that the first super capacitor module 40 and the second super capacitor module 50 are still connected in parallel and discharge to the power load apparatus 30 through the diode 118, so that the voltage of the power load apparatus 30 is just decreased to be a little bit lower than the voltage which is provided by the first super capacitor module 40 and the second super capacitor module 50 which are connected in parallel, so that the power load apparatus 30 can still work without the voltage-dropping problem. Then, once the control unit 102 turns off the first switch unit 104, the third switch unit 108 and the fifth switch unit 112, and once the control unit 102 turns on the second switch unit 106 and the fourth switch unit 110, the voltage of the power load apparatus 30 is increased, so that the diode 118 is turned off.

The advantage of the present invention is that the charging discharging apparatus has both the advantages of the charging in parallel and discharging in series, but the present invention does not have the disadvantages of the discharging in parallel and charging in series.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A charging discharging apparatus applied to an input power apparatus, a power load apparatus, a first super capacitor module and a second super capacitor module, a negative terminal of the first super capacitor module connected to ground, the charging discharging apparatus comprising:
a control unit;
a first switch unit electrically connected to the control unit, the input power apparatus and the power load apparatus;
a second switch unit electrically connected to the control unit, the power load apparatus, the first switch unit and the second super capacitor module;
a third switch unit electrically connected to the control unit, the second switch unit, the second super capacitor module and the first super capacitor module;
a fourth switch unit electrically connected to the control unit, a negative terminal of the second super capacitor module, the third switch unit and the first super capacitor module; and
a fifth switch unit electrically connected to the control unit, the fourth switch unit, the negative terminal of the first super capacitor module, the negative terminal of the second super capacitor module and ground,
wherein when the input power apparatus sends an input power to the charging discharging apparatus, the control unit turns off the second switch unit and the fourth switch unit, and the control unit turns on the first switch unit, the third switch unit and the fifth switch unit, so that the power load apparatus receives the input power through the first switch unit, and the first super capacitor module is connected to the second super capacitor module in parallel, and the first super capacitor module and the second super capacitor module are charged;
wherein when the input power apparatus stops sending the input power to the charging discharging apparatus, the control unit turns off the first switch unit, the third switch unit and the fifth switch unit, and the control unit turns on the second switch unit and the fourth switch unit, so that the first super capacitor module is connected to the second super capacitor module in series, and the first super capacitor module and the second super capacitor module discharge to the power load apparatus through the second switch unit and the fourth switch unit.

2. The charging discharging apparatus in claim 1 further comprising:
an input power detection unit electrically connected to the control unit, the input power apparatus and the first switch unit,
wherein the input power detection unit detects the input power and informs the control unit of a status of the input power, so that the control unit is aware that whether the input power apparatus sends the input power to the charging discharging apparatus or not; when the input power apparatus sends the input power to the charging discharging apparatus, the input power detection unit detects the input power and informs the control unit that the input power is sent to the charging discharging apparatus, so that the control unit is aware that the input power apparatus sends the input power to the charging discharging apparatus; when the input power apparatus does not send the input power to the charging discharging apparatus, the input power detection unit does not detect the input power and informs the control unit that the input power detection unit does not detect the input power, so that the control unit is aware that the input power apparatus does not send the input power to the charging discharging apparatus.

3. The charging discharging apparatus in claim 2 further comprising:
a charging unit electrically connected to the control unit, the input power apparatus, the first switch unit, the input power detection unit, the third switch unit, the fourth switch unit and the first super capacitor module,
wherein when the input power apparatus sends the input power to the charging discharging apparatus, the control unit controls the charging unit to receive the input power to charge to the first super capacitor module and the second super capacitor module.

4. The charging discharging apparatus in claim 3, wherein the control unit is a microcontroller, a microprocessor or a logic circuit.

5. The charging discharging apparatus in claim 4, wherein the first switch unit is a metal oxide semiconductor field effect transistor or a bipolar junction transistor; the second switch unit is a metal oxide semiconductor field effect transistor or a bipolar junction transistor; the third switch unit is a metal oxide semiconductor field effect transistor or a bipolar junction transistor; the fourth switch unit is a metal oxide semiconductor field effect transistor or a bipolar junction transistor; the fifth switch unit is a metal oxide semiconductor field effect transistor or a bipolar junction transistor.

6. The charging discharging apparatus in claim 5, wherein the input power detection unit is an input power detection circuit.

7. The charging discharging apparatus in claim 6, wherein the charging unit is a charging circuit.
